(19) United States
(12) Patent Application Publication
(10) Pub. No.: US 2005/0259421 A1
(43) Pub. Date: Nov. 24, 2005

(54) Decorative light switch

(76) Inventor: Matthew S. Smith, St. Charles, MO (US)

Correspondence Address: Paul M. Denk, Ste. 170, 763 S. New Ballas Road, St. Louis, MO, 63141, US

(21) Appl. No.: 11/129,591

(22) Filed: May 13, 2005

Related U.S. Application Data
(60) Provisional application No. 60/571,955, filed on May 17, 2004.

(51) Int. Cl. F21L 4/00

(52) U.S. Cl. 362/253

(57) ABSTRACT

A variable light switch, which can be molded or formed into various configurations, caricatures, images of prominent people, is provided upon the light switch and which can be actuated for illumination of an associated light through circuitry. This switch may incorporate other emitting features, such as a low level of illumination, within the switch itself, either form a lamp, LED, or other light emitting devices, and when energized, either from a step down transformer, or from a battery, provides for such illumination. Or, the switch can energize and achieve the emanation of any sound, through a bell, siren, or the like, or even incorporate micro-circuitry to transmit a sound, or voice, of simulating the facial feature shown, where that type of a switch is formed.

### CROSS REFERENCE TO RELATED APPLICATION

This nonprovisional patent application claims priority to the provisional patent application having Ser. No. 60/571,955, which was filed on May 14, 2004.

### BACKGROUND OF THE INVENTION

Numerous light switches have been available in the art. Generally these are located in children's rooms, and the like, starting to add to the attractiveness of the switch, and be aesthetically pleasing to the children.

The purpose of this current invention is to provide a light switch that can act as an attractant to children, and please them with its visual aesthetics.

### SUMMARY OF THE INVENTION

This invention contemplates a new style of light switch for application to rooms, halls, and the like, particularly children's rooms, and to enhance their attractiveness and novelty during usage.

The concept of this invention is to add a customizable decor switch component that may replace, adhere, fix to, or fasten to an existing switch, in order to add to the attractiveness of such a switch particularly when provided within a child's room. Essentially, the switch will be molded of a variety of materials, preferably polymer, or ceramics, and which may add grotesque or otherwise alternatively appearing characters to the switch, provide a switch means that may be accentuated in this design, and which may include additional lights, bells, or the like, so as to let the child know when the switch has been initiated, and the light has either been turned on, or turned off, as desired. The object is to create a visual/physical change to the existing light switch, and give it character, and relay an attitude reflecting the graphic treatment of the switch plate. The switch may act like the traditional switch, or it may have other shapes upon its surface, such as faces, or the like, and may even emanate sounds, verbal sounds, which may be associated with the type of face which the switch may portray. For example, in addition to providing grotesque figures or faces, the switch may also be molded to provide the appearance of a prominent athlete, actor/actress, politician, such as a President, and the like. In this day and age, a chip can be provided within a microcircuit to emanate and transmit a sound to known sounds and voices, and which could be built into the structure of this light switch during usage. A motion sensor within the switch could be used to initiate the sound of a voice, or other noise, when anyone walks within the vicinity of the switch. Or, as previously reviewed, the light switch may in alternative embodiments be decorated with caricatures that may be grotesque, may appear to be fantasy, have a large type of switch incorporated for manipulation to turn on or off the light, and the light itself may be generated within the knob, which may be transparent or translucent, to provide for the illumination of the switch, when actuated. Any type of illuminating lamp, LED, or the like, as previously described, may be incorporated therein to achieve such. Furthermore, as stated, one or more sounds may be used to create a fun and/or interactive effect, when the switch is initiated. These can be triggered by additional buttons, switches, or the existing switches on the plate, a motion sensor, or the like. The buttons or switches are not limited to a physical action, such as their depressing or flicking on, but can be achieved by other sources, such as motion, light, sound, or heat activated. The power needed to supply electricity to the switch plate can come from one or two places. Even a battery compartment inside the switch plate can contain one or more appropriate batteries to provide for energization of these other auxiliary components.

Electrically, where the light switch is applied to an existing 110 Volt AC line, it might include a transformer that may be required in order to step down the voltage, and to provide the type of power sufficient to activate light, sounds, or other activating devices, that operate off of a lower voltage.

In any event, it should be understood that the concept of this invention is to provide and incorporate light, perhaps sound, and even motion, into a switch plate, and one that may be applied to a wall, to furnish a switch on or switch off of another light, within the vicinity, and electrically connected thereto.

It is, therefore, the principal object of this invention to provide a highly characterized or instrument light switch, which can be activated by manual turn on, motion, heat, or the like, to furnish an exciting type of illumination, for an adjacent or circuit connected light, and further transmit noise, voice, light, when actuated.

These and other objects may become more apparent to those skilled in the art upon review of the summary of the invention as provided herein, and upon undertaking a study of the description of its preferred embodiment in view of the drawings.

### BRIEF DESCRIPTION OF THE DRAWINGS

In view of the drawings, FIG. 1 discloses an embodiment for a light switch of this invention having a plate structure, that is embellished with caricatures, clouds, or steam surrounding its vicinity, and wherein the switch itself when initiated to an ON position illuminates associated components, perhaps the cloud structure or the face of the caricatures, when illuminated;

FIG. 2 provides another light switch similar to the previous, but also furnishing that audio sound, as from its bell, and other actuators as noted, when the switch is initiated to an ON position; and

FIG. 3 shows a brief schematic circuitry of how the light switch may be used upon the wall, and may have internal electronic components, to provide sound, or other lighting, within the switch, but at the same time, actuate the light within the room, through circuitry.

### DESCRIPTION OF THE PREFERRED EMBODIMENT

Referring to the drawings, and in particular FIG. 1, the light switch of this invention is disclosed. In this instance, it may include a variety of caricatures, shown at 1, and having actuating switch 2, or other translucent switch 3, itself, when the light is turned on. Other types of transmitters may be employed, such as the various reflectors, as can be seen at 4, which the further lighted, by use of LED's, or the like, which may be battery operated, when the switch is turned on. In addition, the light switch may include various background materials, such as the clouds as noted at 5, which may also be illuminated, during functioning and usage of the switch.

Previously referred to, it is just as likely that the switch may include and be molded, such as with a polymer, or ceramic to provide the configuration of a facial feature, such as that of a prominent athlete, actor/actress, politician, such as a president, and the like. Furthermore, micro-circuitry may be provided within the switch, so that when it is turned on, voices may be actuated, from the caricatures, as shown. In addition, there may be micro-circuitry provided within the switch, such as a transformer from the 110 AC voltage and current, or in addition, it may incorporate a battery, at the 9 volt or related level, and which may initiate various sounds, sirens, voices, or the like, during usage and actuation.

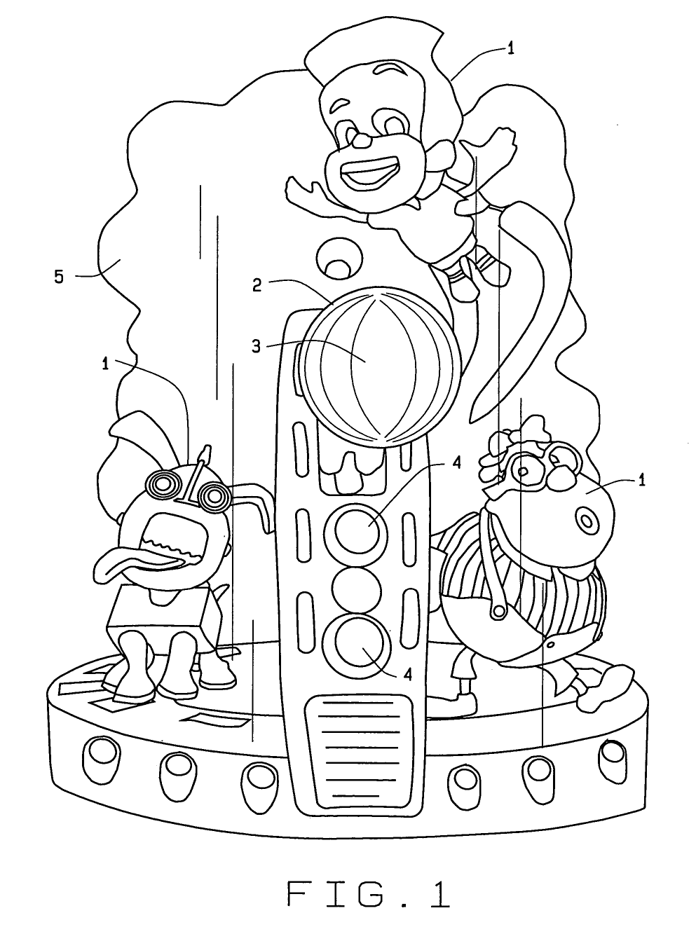

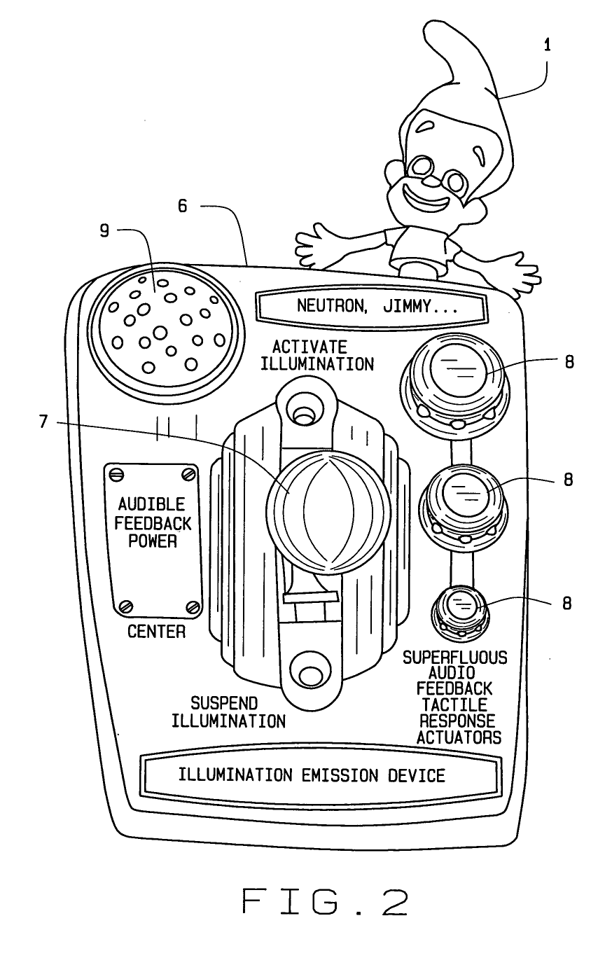

FIG. 2 provides another form for actuating the switch similar to that as previously described, but provides a variation upon the switch of this invention. When the switch is installed, and its switch 7 itself, is actuated, or pulled down to turn On or turn OFF the light, there may be light emitted from the switch 7 itself, or along other features that are provided upon the switch, such as the switch itself, or the reflectors 8, to reflect light, or perhaps even an audio sound through the alarm 9 may be emitted, from the same switch, when it is turned on and provides for illumination.

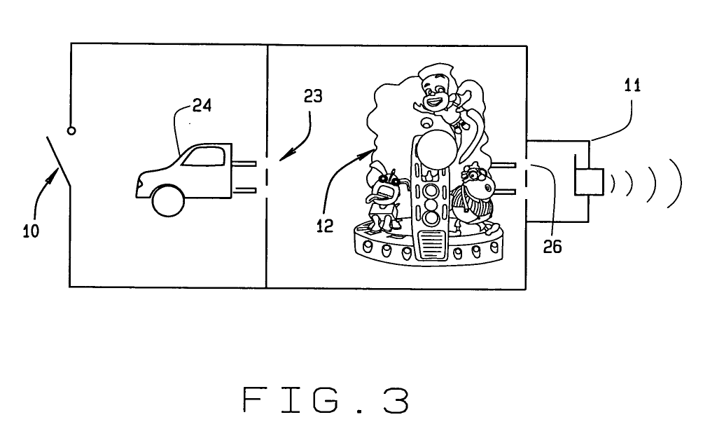

FIG. 3 is an example of the type of circuitry that may be used with this invention as can be seen. This is simply a circuitry which discloses a light switch, that provides energy to some other electrical appliance, whether it be a light, or the like, and the internal components of the switch 10 as previously alluded to, may be initiated, such as, for example, to emit a sound as from the alarm similar to that as at 9, or to provide for a slight glowing of the switch 7 itself, or perhaps its reflectors 8, when the switch is turned on and other appliances energized, such as a ceiling light, wall light, or the like. In addition, various features of this light may likewise either through a stepped down voltage, illuminate certain portions of the switch, or a battery therein may be energized, for initiating the alarm 9, or reflect light through the reflectors 8, even from LED's, as can be understood.

It is just as likely that the light switch, and its circuitry, may include other types of actuating features, such as a motion sensor 11, known in the art, and which can be provided within the circuitry, and can act in conjunction with the switch, such as shown in FIG. 4, a switch as noted, when it detects a motion, and will provide for an illumination of light or other appliance, and emanate sounds or lights from the switch itself, as previously reviewed. For example, the character 1 upon the light switch of FIG. 1 can provide for a whistling noise, from one of the FIG. 1, as shown at the lower right hand corner of FIG. 1.

Obviously, the subject matter of this invention as depicted in the various models as disclosed can vary extensively, add any type of caricature, each of a figure, as previously explained, and any other features, that can be embodied into the structure, such features and figures that may catch the fancy of the child, when installed, and during usage. These are all envisioned within the concept of this invention. Furthermore, various types of sounds may emanate from the light switch, in the manner as previously summarized, for this invention, and they may be actuated manually, as by initiation of the switch, or even through a motion detecting device, or even a heat sensing instrument, as can be understood.

Variations or modifications to the subject matter of this invention may occur to those skilled in the art upon review of this invention as disclosed herein. Such variations, if within the spirit of this development are intended to be encompassed within the scope of any invention as explained. The description of the preferred embodiment, and its depiction in the drawings, are set forth for illustrative purposes only.

1. A decorative light switch for use in connection with standard light switch provided electrically connected upon the wall of a room, a decorative light switch having various configured caricatures, designs, or images of prominent people integrally formed upon its exposed surface, the light switch capable of being secured to the standard light switch and allowing for an initiation and turn ON of at least one light source, said decorative light switch including a switch means having a bulbous end, said bulbous end of the light switch being translucent so as to emanate light therethrough when the switch is turned ON, said light switch having illuminating means located at select interior locations about said switch, to provide for illumination of select of the configurations, caricatures, or images of prominent people therewith, said light switch, upon its energization, further providing for emanation of a sound, and said switch capable of being turned on manually, by way of motion sensing, or by heat sensing, to achieve the turn on of the decorative light switch and a variety of emitted light and sound elements.

2. The decorative light switch of claim 1 and including micro-circuitry provided within the light switch to provide for initiation and emanation of the various light and sounds from the switch when initiated.

3. The decorative light switch of claim 2 and wherein said energization is achieved through hard wiring to the circuitry of the wall light switch.

4. The decorative light switch of claim 2 wherein the energization for the light and sound from the light switch is obtained from at least one battery.

5. The decorative light switch of claim 2 wherein caricatures provide facial features of animated characters.

6. The decorative light switch of claim 2 wherein the switch is provided upon said light switch or the facial features of prominent people, and the micro-circuitry providing for the emanation of a voice sound similar to the person portrayed when the light switch is energized.

7. The decorative light switch of claim 6 wherein the energization of the light switch is obtained through a manual turn-on of said switch.

8. The decorative light switch of claim 6 wherein the light switch is initiated through motion detection of one moving within the room.

9. The decorative light switch of claim 6 wherein the light switch is turned on through heat sensing of anyone present in the adjacent room.

10. The decorative light switch of claim 5 wherein the figurations provided upon the exterior surface of the light switch is that of a vehicle, and when said light switch is turned on a sound comparable to an operating vehicle is temporarily emitted upon energization of said switch.

11. The decorative light switch of claim 2 wherein said switch is made of polymer.

12. The decorative light switch of claim 2 wherein the said switch is made of ceramics.

13. The decorative light switch of claim 2 wherein the entire switch is made translucent, an LED's provided behind select features of the configurations, caricatures, or images of prominent people provided integrally upon the surface of the light switch, to provide for their illumination when the light switch is energized.
